(19) United States
(12) Patent Application Publication
(10) Pub. No.: US 2012/0305598 A1
(43) Pub. Date: Dec. 6, 2012

(54) Device and Method for Draining Contents from Containers

(76) Inventor: Colleen L Costello, Englewood, OH (US)

(21) Appl. No.: 13/482,915

(22) Filed: May 29, 2012

Related U.S. Application Data
(60) Provisional application No. 61/519,869, filed on Jun. 1, 2011.

(51) Int. Cl. F16M 13/00

(52) U.S. Cl. 222/185.1; 248/346.07

(57) ABSTRACT

A device for the support and suspension of inverted containers for the purpose of facilitating the draining of the typically diminished contents from the containers. The device comprises a top member having an orifice for inserting and accommodating variously-sized inverted containers and a flexible, yet rigid, wall member having segments of increasing circumference from the top to the base of the device and wherein the segments are defined by and have a plurality of creases that permit inward and outward folds that allow for an adjustable height for the device and the complete collapse of the top and wall of the device into the circumference of the largest wall segment.

### FIELD OF THE DISCLOSURE

This disclosure relates generally to a device for supporting inverted containers to facilitate the removal of liquids from the containers. More specifically, the disclosed device is conformable to accommodate a variety of different sized and shaped containers and collapsible to be easily and conveniently stored when not in use. It is particularly well suited to facilitate draining the viscous remnants of common consumer products that are slow or difficult to dispense as the container is depleted.

### DESCRIPTION OF THE PRIOR ART

The most relevant prior art to the disclosed device includes U.S. Publication No. 2011/028457 to McElligott et al. which describes a collapsible cup having a base and a series of cylindrical body segments that together form a rigid cup body. In its embodiment most relevant to the instantly disclosed device, the McElligott et al. collapsible cup is threaded for its support and adjustability and thus bears no structural resemblance to the device disclosed herein. U.S. Pat. No. 3,434,589, which issued to Valtri et al. on Mar. 25, 1969, describes a compressible-expandable cup having an annular wall, alternately increasing and decreasing diametrically, forming accordion-like folds and means for retaining the cup in a fully compressed form until removed, whereupon the cup springs to an uncompressed predetermined height. Clearly, the relevant prior art is clever and interesting but unrelated to the device disclosed herein.

### SUMMARY OF THE DISCLOSURE

Specifically, and with deliberate particularity, the device set forth and described herein is an aid in draining the contents, typically viscous remnants, from a container. More specifically, the described device supports and permits the suspension of an inverted container for the purpose of allowing the container to drain or empty as completely as desired. Essentially, the device comprises a top member, at the upper end of the device, having a centrally positioned flexible orifice to accommodate variously-sized inverted containers and a flexible wall member. Preferably, in addition to the top and flexible wall members, the device employs an annular base member, at the lower end of the device, to lend structural support and stability to the device.

So, between and attached to both the base member and the top member is a flexible wall member having a plurality of annular segments, each segment increasing in circumference from said upper-end to said lower-end and each segment defined by a plurality of annular creases allowing inward folds and each segment having a plurality of annular creases allowing inward and outward folds within said segments, said creases and folds thus permitting each segment to fold and collapse within the circumference of the adjacent larger segment or unfold and extend from the adjacent larger segment.

Also described for the edification of all is the method of using the instantly disclosed device to effect the removal of remnants, dregs and diminished contents from an inverted container safely and securely suspended over a receptacle sized for the receipt of drained contents.

### BRIEF DESCRIPTION OF THE DRAWING

FIG. 1 is a perspective view of the currently preferred embodiment of the disclosed device in its fully-extended mode.

FIG. 2 is a perspective view of the disclosed device in its fully collapsed mode to facilitate storage.

FIG. 3 is the disclosed device adjustably and partially collapsed with segment Z collapsed within the circumference of the base member.

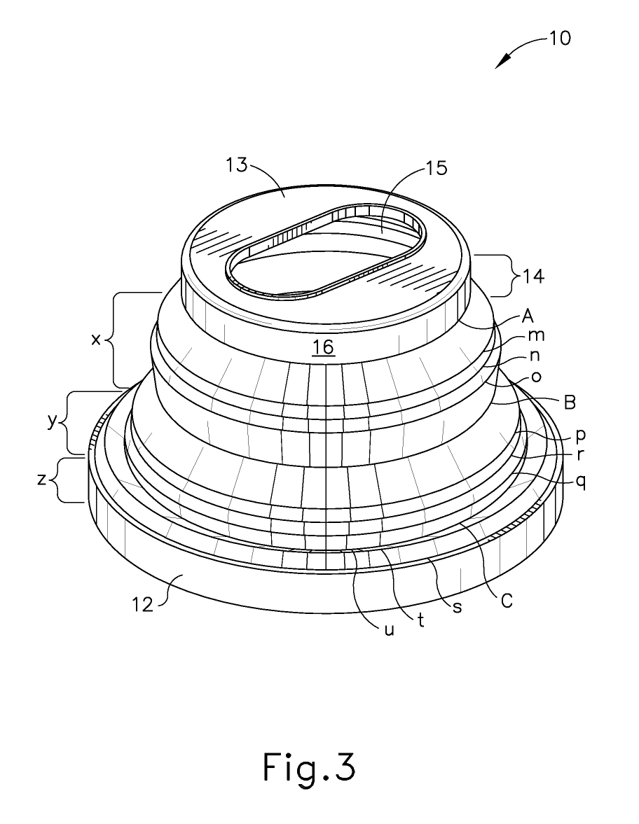

FIG. 4 is a cross-sectional view of the device with a container, saucer and draining contents in phantom to illustrate the method of using the disclosed device.

### DESCRIPTION OF THE PREFERRED EMBODIMENTS

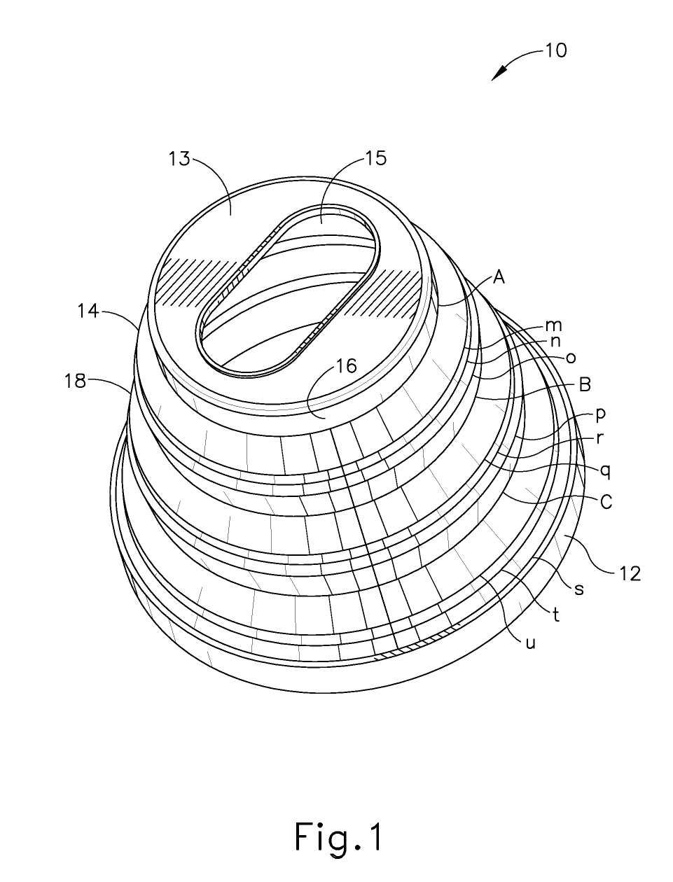

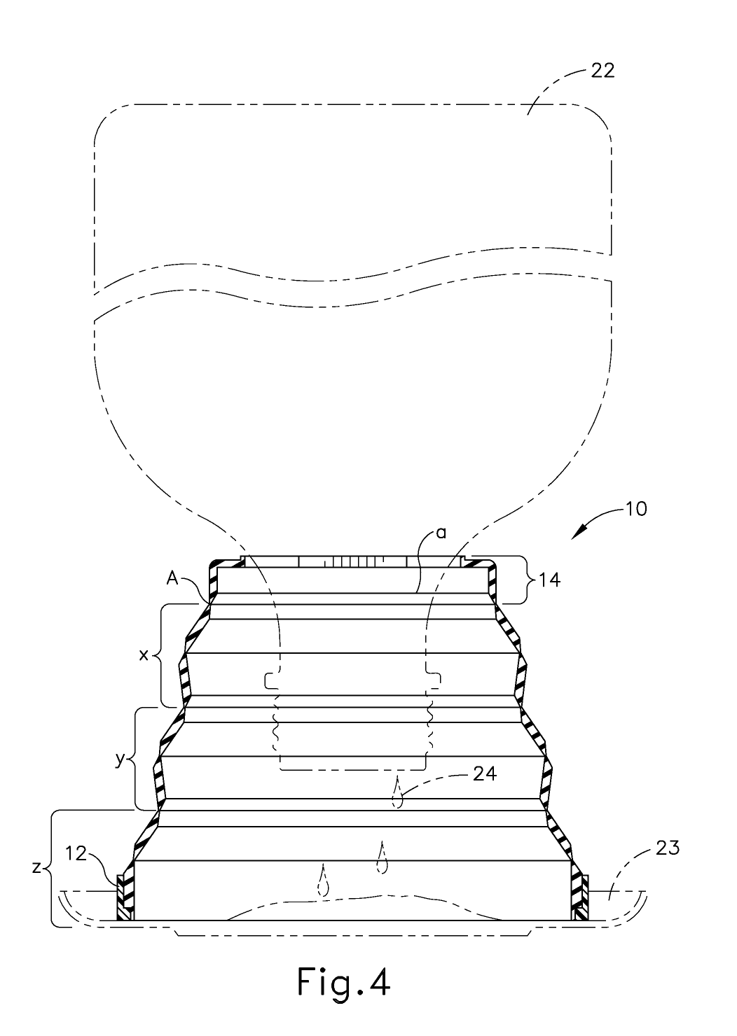

A complete appreciation of the disclosed device is facilitated by referring to the accompanying drawing. Referring initially to FIG. 1, an elevated perspective view of the disclosed device 10, the top member 14 of the device is immediately apparent. The top member consists of an upper-most annular flat surface area 13 having a centrally positioned orifice 15 supported by an annular wall 16. Typically, as the contents of a container are diminished by use or dispensing, removal of the remaining contents becomes more difficult, especially if the contents are viscous. The functional purpose of the top member 14 is to provide and define the orifice 15 into which an inverted container is placed to allow gravitational forces to effect the removal of all or almost all of the contents of the container. Empirical studies have shown that an elongated or oval orifice having a flexible perimeter accommodates the largest number of containers. The flexibility of the perimeter of the orifice 15 not only permits the insertion of variously sized containers, but the flexible perimeter also provides a “soft,” non-rigid, and more secure grip on the inverted container. FIG. 4, a cross-sectional view of the disclosed device 10, provides an illustration of the use of the device with the inverted container 22, receptacle (saucer) 23 and draining contents 24 shown in phantom. It should be mentioned that it is not necessary or essential that the disclosed device 10 be used only with a receptacle to drain the lingering contents from the inverted container into the awaiting receptacle. It is perfectly permissible for the inverted container to be capped so that the contents accumulate at the capped opening in the container, thus facilitating their removal from the container as they accumulate prior to complete evacuation of the container.

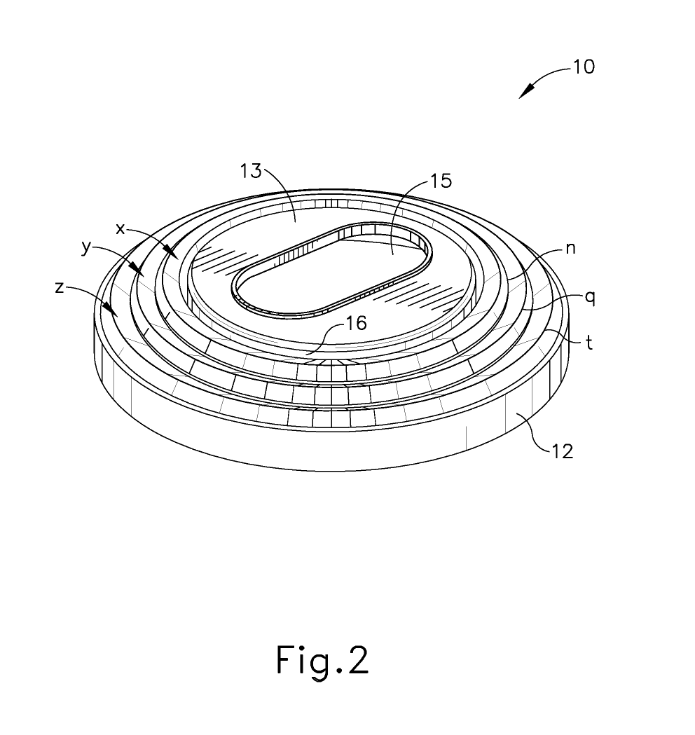

Referring again to FIG. 4, it is appropriate to remove all doubt as to the recommended use of the disclosed device 10. In most instances, the device will be retrieved from storage in the collapsed mode depicted in FIG. 2. The flexible wall member 18 is extended to the desired height by grasping the base member 12 in one hand and placing a finger or two of the other hand into the orifice 15 of the top member 14 and exerting slight outward radial force on the two ends of the device. The segments of the wall member will extend sequentially. The desired height is determined, the larger end of the device is positioned over a receptacle 22, if external (uncapped) collection is desired, and an open-ended container is inverted and inserted into the orifice 15 until secured. Any contents in the container will drain, over time, into the receptacle. When the container is sufficiently drained, the inverted container is removed, the device is washed, if necessary, and collapsed for storage. Collapsing the device requires little more that exerting slight inward radial force on the two ends of the device. Typically, the base end of the device is placed on a flat, stable surface and downward force is applied to the top member of the device, and the accordion-like folding and collapsing commences.

To continue with the description of the disclosed device 10, return to FIG. 1 wherein the base member 12 of the device is readily apparent. The base member 12 has a defined perimeter determining the size of the device and is preferably annular in shape. It is diametrically opposite the top member 14 and provides support for the device when in use and “houses” the other elements of the device when it is collapsed and stored.

Positioned between the top member 14 and the base member 12 of the device 10 is flexible wall member 18. The wall member comprises a plurality of segments X, Y and Z. Each segment is defined by at least one major collapsing crease: A, B and C. As currently configured, segment X is defined by major collapsing creases A and B, segment Y is defined by major collapsing creases B and C and segment Z is defined by major collapsing crease C and the bottom of the wall member 18. In other words, the terminus of segment Z is the bottom of the device. The major collapsing creases fold inward toward the center of the device and, appropriately enough, allow the top member 14 and segments X and Y of the device to collapse within the circumference or confines of the larger adjacent segment of the device.

Within each segment are a plurality of folding creases. Within segment X are folding creases m, n and o. Within segment Y are folding creases p, q and r. And, within segment Z are folding creases s, t and u. The folding creases permit the segments to fold approximately in half and allow for the collapse of the segments along the collapsing creases.

In FIG. 4 the device 10 is fully extended and all of the segments and all of the creases are readily apparent. As the disclosed device 10 is currently depicted, three reductions in the size of the device can be made. From top to bottom, the top member 14 can be collapsed within the confines or circumference of segment X by urging major collapsing crease A to fold inward which permits folding creases m, n and o to enable crease n to fold and extend outward.

The device 10 can be further reduced in height by urging major collapsing crease B to fold inward which permits folding creases p, q, and r to enable crease q to fold and extend outward, thus allowing segment X and top member 14 to collapse within segment Y. For purposes of clarity, it is not mandatory that top member 14 accompany the collapse of segment X into segment Y, but if there is justification for denying the collapse of the top member, or any other smaller segment during height reduction of the device 10, the top member and any smaller segments can be easily re-extended.

And, finally, if complete reduction of the height of the device is desired as for purposes of storage, the combination of the top member 14, segment X and segment Y can be collapsed within the circumference or confines of segment Z by urging major collapsing fold C to fold inward which permits creases s, t and u to enable crease t to fold and extend out, thus permitting the complete collapse of the device. Total collapse of device 10 is clearly depicted in FIG. 2.

It is also apparent from FIG. 2 that base member 12 preferably encompasses the entire device 10 in its collapsed mode. While not absolutely essential to the function of the device, empirical studies have shown that the base member 12 adds to the stability and integrity of the device. The base member can be easily and permanently affixed to the lower portion of segment Z. Experimental attempts to eliminate it from the design of the device diminish the ease of use and stability of the device 10.

Preferred embodiments of the disclosed device 10 are currently fabricated from a variety of plastic materials. The device is manufactured by injection molding. The flexible wall member 18 and top member 14 are molded from elastomeric silicones specifically blended to provide the ideal flexibility, integrity and durability. Clearly the wall member, when fully or partially extended, needs to demonstrate sufficient structural integrity to support a partially filled container of meaningful size and be flexible enough to fold and collapse into smaller sizes, as appropriate for use, and/or ultimately collapse completely for storage. Also, the elastomeric nature of the top member and its orifice enables the device to adapt to a wide range of container designs so that a variety of container shoulders and necks can be accommodated. The base member 12 is currently not perceived as needing the flexibility of the top and wall members, so it is preferably molded from a plastic such as PVC, polypropylene or polyethylene. And, clearly, all elements of the device need to demonstrate sufficient durability to withstand repeated cleanings and use.

While the foregoing is a detailed and complete description of the preferred embodiments of the disclosed device and its use for supporting and suspending inverted containers to facilitate the removal of contents from the container, it should be apparent that numerous variations and modifications can be made and employed to implement the overall purpose of the disclosed device without deviating or departing from the spirit of the invention, which is fairly defined by the appended claims.

1. A device having an adjustable height to support and suspend inverted containers for the purpose of draining viscous contents from said containers, said device comprising:
an annular top member having a centrally positioned flexible orifice to accommodate variously-sized inverted containers; and,
a flexible annular wall member having an upper-end attached to said top member and a lower-end, said wall member comprised of a plurality of annular segments, each segment increasing in circumference from said upper-end to said lower-end and each segment defined by a plurality of annular creases allowing inward folds and each segment having a plurality of annular creases allowing inward and outward folds within said segments said creases and folds thus permitting each segment to fold and collapse within the circumference of the adjacent larger segment or unfold and extend from the adjacent larger segment.

2. The device according to claim 1 further including an annular base member attached to the lower end of said wall member.

3. A method for draining the contents from a container having diminished contents, said method comprising:
positioning and adjusting the height of a suspending device which comprises:
an annular top member having a centrally positioned flexible orifice to accommodate variously-sized inverted containers; and,
a flexible annular wall member having an upper-end attached to said top member and a lower-end, said wall member comprised of a plurality of annular segments, each segment increasing in circumference from said upper-end to said lower-end and each segment defined by a plurality of annular creases allowing inward folds and each segment having a plurality of annular creases allowing inward and outward folds within said segments said creases and folds thus permitting each segment to fold and collapse within the circumference of the adjacent larger segment or unfold and extend from the adjacent larger segment;
inverting and inserting said container into said flexible orifice; and,
allowing the contents of said inverted container to drain into a receptacle.

4. The method according to claim 3 wherein the suspending device further includes an annular base member attached to the lower end of said wall member.

5. The method according to claim 3 wherein the inverted container is capped and said contents are allowed to accumulate in said inverted container.
